(19) United States
(12) Patent Application Publication
(10) Pub. No.: US 2002/0129355 A1
(43) Pub. Date: Sep. 12, 2002

(54) Method and system for monitoring an apparatus for a computer

(76) Inventors: Mike Velten, Plain City, OH (US); Brian Clemans, Hilliard, OH (US); Win Worcester, Powell, OH (US)

Correspondence Address: HOWREY LLP, 750 Bering Drive, Houston, TX, 77057-2198, US

(21) Appl. No.: 10/085,423

(22) Filed: Feb. 28, 2002

Related U.S. Application Data
(60) Provisional application No. 60/272,664, filed on Mar. 1, 2001.

(51) Int. Cl. G06F 9/445

(52) U.S. Cl. 717/176; 709/220

(57) ABSTRACT

A system for monitoring various support devices of a computer network is disclosed. The network has a monitoring computer with a monitoring program that monitors the devices. The monitoring program is used to configure a subordinate program. Using push technology, the subordinate program is installed on and is run on target computers in the network. The monitoring program monitors operating parameters and alarm signals from the devices. When the monitoring program determines that the devices can no longer support its load, the monitoring computers sends a shut down instruction to the affected target computers. The subordinate program executes a shutdown routine for the target computer based on the shutdown instruction sent from the monitoring program. The subordinate program has minimal or no graphical user interface on the target computer and requires no local configuration by the user of the target computer.

### CROSS-REFERENCE TO RELATED APPLICATIONS

This application claims the benefit of the Provisional Application Serial No. 60/272,664 filed Mar. 1, 2001.

### FIELD OF THE INVENTION

The present invention relates generally to a monitoring system for a computer, and more particularly to, a system for monitoring an apparatus or device, such as an uninterruptible power supply (UPS), for a computer on a network.

### BACKGROUND OF THE INVENTION

Computers in a network depend on a number of devices to provide power, ensure operating parameters, or maintain environmental conditions. Such devices include power supply, distribution and conditioning devices environmental monitoring and control devices and other facility monitoring and control devices. For example, an uninterruptible power supply (UPS) provides power to computers and other devices in a network during disturbances in commercial power. The UPS uses an auxiliary power source, such as batteries, to power the equipment in the network for a limited amount of time before the computers or other devices must be shutdown. When the batteries in the UPS have completely discharged, loss of data will occur if proper steps are not taken to protect the data.

For this reason, a system may be implemented that monitors the UPS, determines when shutdown is imminent and notifies computers in the network to shutdown. The monitoring system has a program that monitors the UPS and provides alarm signals, such as low battery alarms and power failure alarms, to the other computers in the network. A program on the other computers monitors the alarms and controls the shutdown of the computers.

Traditional monitoring systems use a graphical user interface (GUI) to operate on the computers of the network. Conventional programs on the computers may have an extensive graphical user interface, requiring a significant amount of storage and RAM on each computer in the network. The basic features required for UPS monitoring, however, do not require a GUI environment.

In addition, a network may use any of a number of computer operating systems, and an extensive GUI environment limits the portability of a monitoring system to various operating systems. Each operating system uses different methods to display information using a graphical user interface. A monitoring system with an extensive GUI environment must be compatible with the operating system. Therefore, the conventional programs on the computers of the network must contain the code necessary to provide for the GUI environment for the operating systems and must be converted to properly operate with the various operating systems.

Furthermore, installation of the conventional program of the computers on the network requires difficult and lengthy configuration. Given that a network may have upwards of five thousand workstations, installing and updating the programs on each of the computers is labor intensive. Technicians must physically install and configure the programs on the individual computers of the network. Due to the difficulties described above, most of the computers on a network are not properly equipped with shutdown software.

The present invention is directed to overcoming, or at least reducing the effects of, one or more of the problems set forth above.

### SUMMARY OF THE INVENTION

In view of the foregoing and other considerations, the present invention relates to a system that monitors an apparatus, such as an uninterruptible power supply (UPS). The system determines the potential effect of the apparatus on computers in a network, such as the ability of the UPS to handle the load connected to it, and signals the computers on the network to perform an orderly shutdown, if necessary.

The present invention includes a method for monitoring an apparatus, which provides support for computers of a network. The method includes the steps of configuring a subordinate program with a monitoring program on a monitoring computer and pushing the subordinate program from the monitoring computer to a target computer on the network. The method further includes the steps of receiving a message from the apparatus with the monitoring computer, determining from the message if a shutdown condition exists, and transmitting a shutdown instruction from the monitoring program to the subordinate program if the shutdown condition exists.

In one embodiment, the present invention includes a monitoring computer that monitors an UPS. The monitoring computer has software used to configure a subordinate program. In turn, the subordinate program is used to perform an orderly shutdown of target computers on a network. Configuration of the subordinate program for each target computer on the network is prepared in advance. The pre-configured subordinate program is either “pushed” to the target computers for installation or installed from a disk on the monitoring computer. The pre-configured subordinate program may also be distributed via e-mail, floppy disk, or other removable media.

The subordinate program, once installed on the target computer, runs in the background without any need for user interface. The operation of the shutdown program is transparent to the user of the machine, and minimal or no graphical user interface is offered with the subordinate program. When the monitoring program detects that the UPS is no longer capable of powering the loads that are connected, the monitoring program sends a signal to the subordinate program on the affected target computers, and the subordinate program performs an orderly shutdown of the target computers. Normally, a target computer would receive power from the same UPS as the monitoring computer: however, it may be necessary to shutdown target computers that are being powered by another power source.

### BRIEF DESCRIPTION OF THE DRAWINGS

The foregoing summary, a preferred embodiment, and other aspects of the present invention will be best understood with reference to the detailed description of specific embodiments of the invention, which follows, when read in conjunction with the accompanying drawings, in which:

FIG. 1 illustrates an embodiment of a monitoring system deployed across a network according to the present invention.

FIG. 2A illustrates routines for monitoring an uninterruptible power supply using a monitoring program in accordance with the present invention.

FIG. 2B illustrates routines of a subordinate program on a target computer for receiving shutdown instructions in accordance with the present invention.

FIG. 3 illustrates routines for monitoring a detection device using a monitoring program in accordance with the present invention.

FIG. 4 illustrates another embodiment of a monitoring system in accordance with the present invention.

FIG. 5 illustrates routines performed by an uninterruptible power supply and a target computer for the monitoring system of FIG. 4.

While the present invention is susceptible to various modifications and alternative forms, specific embodiments are shown by way of example in the drawings and are described in detail herein. However, it should be understood that the invention is not limited to the particular forms disclosed. Rather, the invention includes all modifications, equivalents, and alternatives within the scope of the appended claims.

### DETAILED DESCRIPTION OF THE INVENTION

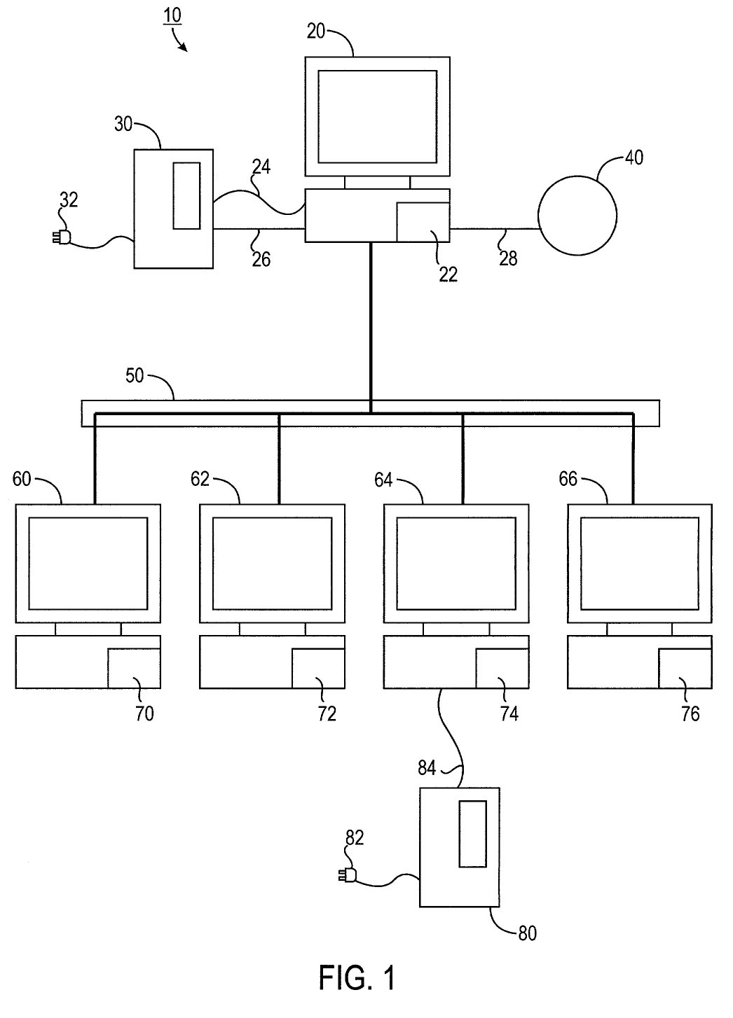

Referring to FIG. 1, a monitoring system 10 according to the present invention is illustrated deployed across a network 50. The monitoring system 10 includes a monitoring program 22 installed on a monitoring computer 20 connected to network 50. Monitoring system 10 also includes a plurality of pre-configured subordinate programs 70, 72, 74, and 76 installed on target computers 60, 62, 64, and 66 also connected to network 50. Monitoring computer 20 can be a server, which manages common data and peripherals for network 50. Alternatively, monitoring computer 20 can be any computer on network 50 having monitoring program 22. Target computers 60, 62, 64, and 66 can be workstations using monitoring computer 20 as a server or can be other computers on network 50.

Monitoring program 22 is designated to monitor one or more apparatus or devices 30, 40, and 80. In a preferred embodiment, the monitored apparatus 30 is an uninterruptible power supply (UPS), which connects to a conventional power supply 32. UPS 30 supplies power to monitoring computer 20 via a cable 24. Monitoring computer 20 communicates with UPS 30 via a connection 26. Monitored apparatus 40 is a detection device, such as a smoke alarm, a burglar alarm, a fire detector, or a water detector. The detection device 40 can even include a detector for unauthorized access to a computer or computer room. Monitored apparatus 80 is another UPS connected to a conventional power supply 82 and supplying power to target computer 64 via a cable 84. Monitoring computer 20 communicates with UPS 80 via another connection (not shown).

The present embodiment is not intended to limit the application of monitoring system 10 to monitoring only uninterruptible power supplies or detection devices, but is only intended to provide one embodiment of monitoring system 10. Monitoring system 10 can monitor any apparatus that supports or interacts with computers in the network. For example, monitoring system 10 can monitor a power distribution or conditioning apparatus for the computers of the network. Monitoring system 10 can monitor emergency power-off circuits or other monitoring systems to which monitoring system 10 is a slave.

Additionally, monitoring system 10 can monitor an environmental unit, which provides temperature or humidity control for a computer. For example, the environmental unit can be an air conditioner, de-humidifier, or chilled water system, among other such apparatus. Due to potential effects of excessive heat or humidity, it may be desirable to shut down those computers on the network effected by or dependent upon the environmental unit if the unit fails. By monitoring the environmental unit, monitoring system 10 can initiate an orderly shutdown of the affected computers.

With the understanding that monitoring system 10 can monitor one or more of a number of apparatus or devices, the communication between monitoring system 10 and the apparatus or device can involve a cable connection or a wireless connection, among other possibilities. For example, monitoring program 10 can have wireless communication with devices, such as cellular telephones, two-way pagers, or wireless personal digital assistants (PDA). In addition, infrared communication can be used for monitoring system 10 to monitor the apparatus or devices.

As discussed above, a significant amount of memory is traditionally used for UPS monitoring software that installs on each target computer of a network. The present invention of monitoring program 22 and subordinate programs 70, 72, 74, and 76 preferably requires a significantly less amount of storage, memory, and CPU cycles on the target computer 60, 62, 64, and 66. Some aspects of the subordinate programs 70, 72, 74, and 76 include the ability of the program to operate with a small footprint and resource usage on the target computers 60, 62, 64, and 66, the ability of the program to operate in the background without user intervention, and the compatibility of the program to operate with various software and hardware products. Additional aspects of the subordinate programs 70, 72, 74, and 76 include the easy and silent installation of the program on the target computers 60, 62, 64, and 66 and the remote configuration of the programs before installation on the target computers.

Monitoring computer 20 with monitoring program 22 performs the main functions of monitoring system 10, while the subordinate programs 70, 72, 74, and 76 on the target computers 60, 62, 64, and 66 function under the direction of monitoring program 22. Monitoring program 22 monitors UPS 30, detector 40, and/or UPS 80 and communicates instructions to the target computers 60, 62, 64, and 66. All of the monitoring and decisions are made by monitoring program 22. Consequently, the subordinate programs 70, 72, 74, and 76 require few resources and can operate in the background of the target computers 60, 62, 64, and 66.

To achieve the compatibility of the subordinate programs 70, 72, 74, and 76 with various software and hardware products, the subordinate programs 70, 72, 74, and 76 are written in a portable code, which eases the conversion of the programs to run on various operating system platforms. For example, the subordinate programs 70, 72, 74, and 76 written in a computer language, such as C, could be compiled and run easily on all the target computers 60, 62, 64, and 66 of network 50, regardless of the operating system, with few modifications. In contrast, programs based on other computer languages may require a large support mechanism on the target computer 60, 62, 64, and 66 and may be expensive to port, which may be undesirable.

The subordinate programs 70, 72, 74, and 76 are also preferably compatible with many of the major operating systems, such as LINUX, Solaris, UNIX, Novell Netware™, or Windows™ NT. Because each operating system uses different methods to display information using a graphical user interface, the subordinate programs 70, 72, 74, and 76 may provide no graphical user interface to be compact and compatible with these various systems. Therefore, operation of the subordinate programs 70, 72, 74, and 76 is transparent on the target computers 60, 62, 64, and 66.

In an alternative embodiment, the subordinate programs 70, 72, 74, and 76 may offer a minimal graphical user interface. For example, in a Windows™ based operating system, a tray icon on the system tray of the target computer may simply show the UPS power source to which the target computer connects and the shutdown delay as set in the configuration. Power supply status may be shown as “Normal” or “Shutdown Pending.”

The subordinate programs 70, 72, 74, and 76 are pre-configured using monitoring program 22. For example, pre-configuration of the subordinate programs 70, 72, 74, and 76 can be handled centrally by a network administrator. Using monitoring program 22, the network administrator remotely configures the subordinate programs 70, 72, 74, and 76 before installation on the target computers 60, 62, 64, and 66. The pre-configuration can designate the source of shutdown instructions to which the target computers 60, 62, 64, and 66 are to respond. The pre-configuration can also set shutdown routines or a shutdown delay for the target computers 60, 62, 64, and 66 to perform once instructed.

Alternatively, the subordinate programs 70, 72, 74, and 76 can have default configuration parameters that may be reset only during installation on the target computers 60, 62, 64, and 66, so that user options are not available on the subordinate programs 70, 72, 74, and 76. Although possible, it is undesirable to allow or require users at the target computers to override or alter the shutdown criteria for the target computers, as that may cause improper operation, premature shutdown, or loss of data. Some of the defaults for configuring the subordinate programs 70, 72, 74, and 76 may include designating the UPS monitoring source, establishing a password to allow shutdown, setting a shutdown delay or configuring a shutdown script.

To install the subordinate programs 70, 72, 74, and 76 easily and silently on the target computers 60, 62, 64, and 66, the subordinate program is “pushed” to all of the target computers 60, 62, 64, and 66 by what is commonly called push technology. Push technology defines the ability of a host system to transfer software to a number of other computers easily and inexpensively via a network. Alternatively, the small, portable subordinate programs 70, 72, 74, and 76 may be pre-configured on monitoring computer 20 and put on a floppy diskette or other removable media. The subordinate programs can then be easily installed on each of the target computers 60, 62, 64, and 66.

In another embodiment of the easy installation of the subordinate programs 70, 72, 74, and 76 on the target computers 60, 62, 64, and 66, the subordinate programs 70, 72, 74, and 76 can be e-mailed to the target computers 60, 62, 64, and 66. Users at the target computers 60, 62, 64, and 66 would only need to click on an attached file of executable code in the e-mail to install the subordinate programs 70, 72, 74, and 76 on the target computers 60, 62, 64, and 66. In addition, the subordinate programs 70, 72, 74, and 76 can be downloaded to the target computers 60, 62, 64, and 66 overnight.

The easy and silent installation of the subordinate programs 70, 72, 74, and 76 insures that most or all of the target computers 60, 62, 64, and 66 in network 50 can be equipped with a shutdown routine. Installation requires no configuration at the target computers 60, 62, 64, and 66. Typical users on the target computers 60, 62, 64, and 66 do not need to know the configuration of the UPS monitoring program on their computers. It may be undesirable to allow the users to access the configuration of the shutdown routine on the target computers 60, 62, 64, and 66.

As discussed above, the subordinate program is “pushed” to all of the target computers 60, 62, 64, and 66 to install the subordinate programs 70, 72, 74, and 76 easily and silently on the target computers 60, 62, 64, and 66. In like manner, the subordinate programs 70, 72, 74, and 76 may “pull” software updates data from the monitoring program 22. The pulled data may include software or configuration updates or other information relevant to the functions of the subordinate programs 70, 72, 74, and 76 on the target computers 60, 62, 64, and 66.

Monitoring program 22 is designated to monitor UPS 30 and/or detector 40. Consequently, monitoring program 22 is charged with the responsibility for the integrity and protection of the data for those target computers 60, 62, 64, and 66 that are dependent upon or effected by the operation of monitoring computer 20, UPS 30, UPS 80, and/or detector 40. Thus, monitoring program 22 is able to determine which computers on the network are dependent upon or effected by the operation of other computers, apparatus, and devices that it monitors.

The monitoring program 22 can include an interface for the network administrator to configure the subordinate programs and to install the subordinate programs on the appropriate target computers from the monitoring computer. The interface of monitoring program 22 can include a plurality of screens or graphical user interfaces that the network administrator uses to operate the monitoring program according to the present invention. As one skilled in the art will readily recognize, monitoring program 22 can be written to be compliant with a number of operating system. For example, information can be displayed in a manner that is similar to the Windows Explorer program that comes with Windows 95/NT/2000 operating systems.

One example of the operation of monitoring system 10 will be briefly discussed. Monitoring program 22 receives signals from UPS 30 via a connection 26 and receives signals from detector 40 via connection 28. Routines executing in monitoring program 22 process the signals. The signals provided by UPS 30 or detector 40 can include status updates, alarm signals, or operating parameters. For example, signals provided by UPS 30 can include voltage levels, “on battery” status, “low battery” status, or “weak battery” status, among other possibilities. Monitoring program 22 can also monitor the target computers 60, 62, 64, and 66 at regular intervals to discover connected or disconnected target computers 60, 62, 64, and 66 on network 50.

UPS 30 can provide only a limited supply of power. If commercial power fails for an extended period and UPS 30 cannot maintain the supply of power, monitoring program 22 determines whether to shutdown monitoring computer 20 and target computers 60, 62, 64, and 66. For example, the decision by monitoring program 22 to shutdown the computers in network 50 can be based on operating conditions of the UPS, such as “on battery” or “low battery”. As a further example, the decision can be based on algorithms using several configurable parameters, such as battery health, utility power quality, or UPS diagnostics.

When the decision to shutdown the affected computers is made, monitoring program 22 sends shutdown instructions through network 50. The shutdown instructions then route to the affected target computers 60, 62, 64, or 66. While monitoring program 20 may typically send shutdown instructions to the affected target computers 60, 62, 64, and 66 that are powered by or dependent upon UPS 30, there are circumstances where shutdown of the computers in network 50 powered by another UPS or powered by utility power alone may be necessary.

To communicate with one another, a protocol is used between monitoring computer 20 and target computers 60, 62, 64, and 66. For example, each target computer 60, 62, 64, and 66 on network 50 can be given a distinct internet protocol (IP) address. Monitoring computer 20 can use a transport protocol, such as TCP/IP or UDP/IP, to communicate with the target computer 60, 62, 64, and 66 over network 50. However, the present invention is not limited to any particular protocol.

To receive and execute instructions from monitoring program 22, the subordinate programs 70, 72, 74, and 76 are pre-configured to respond to a specific shutdown instruction. For example, the specific shutdown instruction can include a predetermined message to the subordinate program that activates shut down routines in the subordinate program. In one embodiment, the subordinate programs 70, 72, 74, and 76 at the target computers 60, 62, 64, and 66 need not know the monitoring computer 20 to which it is to respond. Alternatively, subordinate programs 70, 72, 74, and 76 may be configured only to respond to instructions from the monitoring computer 20.

The subordinate programs 70, 72, 74, and 76 respond to the shutdown instruction by starting a shutdown sequence for the target computer 60, 62, 64, and 66. For example, the shutdown sequence can save data of those target computers 60, 62, 64, and 66 for which monitoring computer 20 is a server. The subordinate programs 70, 72, 74, and 76 then initiate a shutdown routine for the affected or dependent target computers 60, 62, 64, and 66. It is understood that the monitoring computer 20 may also need to be shut down, and the monitoring program 22 may itself include a shutdown routine.

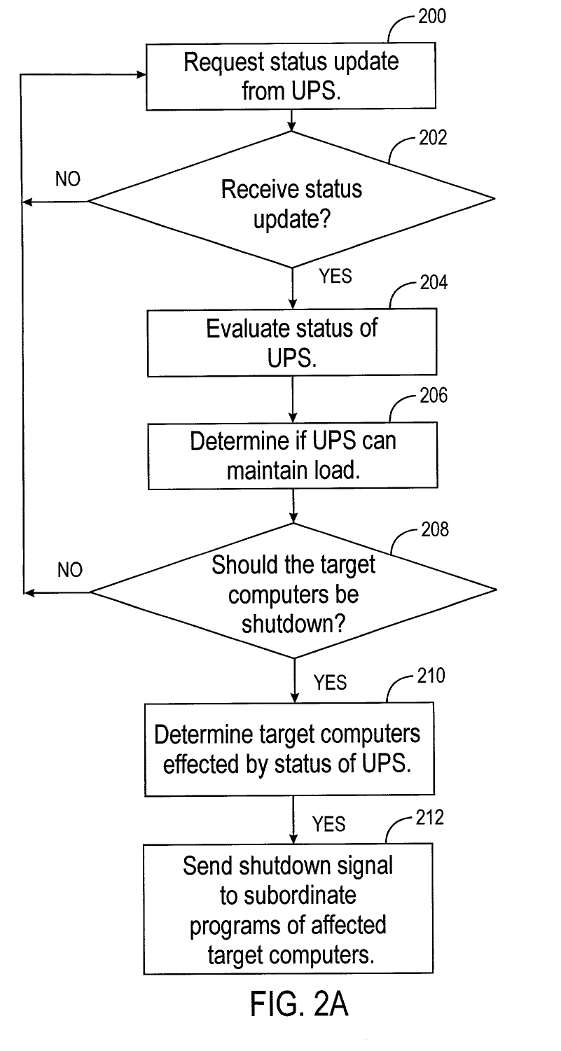

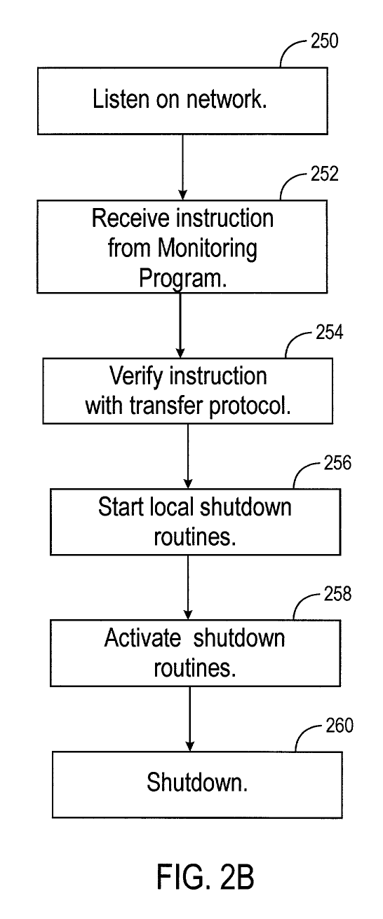

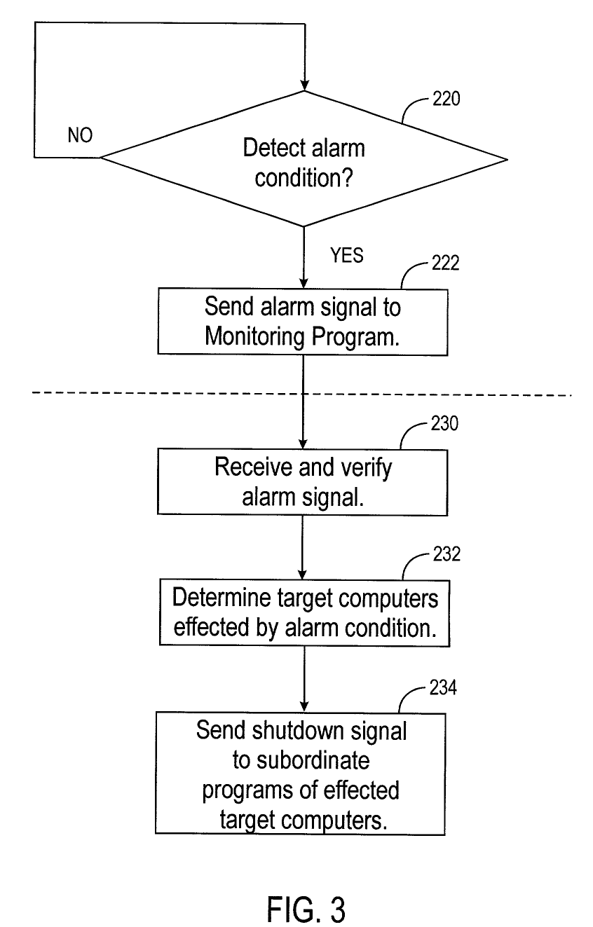

In FIGS. 2A-B, routines for monitoring the UPS with the monitoring program and the subordinate program in accordance with the present invention are illustrated. The routines represent functions or operations performed by the monitoring program and the subordinate program. In FIG. 3, routines for monitoring the detection device using the monitoring program in accordance with the present invention are illustrated.

It is understood that additional features or algorithms may be included in the routines to refine certain functions or operations. It is also understood that additional routines may be either implied or inherent and are omitted herein for the sake of brevity, knowing that one skilled in the art will readily recognize their applicability with the benefit of the present disclosure. Furthermore, reducing the routines into computable and executable programs is well within the ordinary skill of one in the art.

Referring to FIG. 2A, routines for monitoring an UPS device with a monitoring program are illustrated. The monitoring program requests a status update from the UPS to which it is connected (Block 200). Requests can be done at regular intervals or on demand. The monitoring program then tracks receipt of the status update from the UPS (Block 202). Various routines of the program can verify the source and accuracy of the data. An additional request can be submitted due to faulty data or failure to receive the status update. Alternatively, the program may determine that failure to receive an update is equivalent to a failure of the UPS device and may elect to begin the shutdown sequence.

When the status update is properly received from the UPS, the monitoring program evaluates the status of the UPS (Block 204). For example, UPS can have a status indicating that conventional power has failed and the UPS is providing power. The monitoring program then determines from the status whether the UPS can maintain the power supply to the load (Block 206). Specifically, the monitoring program can make decisions based on algorithms using parameters of the UPS and power supply, such as battery health, utility power quality, or UPS diagnostics.

The monitoring program determines whether the target computers should be shutdown (Block 208). The shutdown decision can involve a simple timing scheme for determining the amount of time that the UPS can maintain the load. The shutdown decision can also involve more complex algorithms that use detailed information about the UPS power supply, such as battery health, utility power quality, or UPS diagnostics. If the monitoring program determines that the UPS cannot support the load and that the target computers are to be shutdown, the monitoring program determines which target computers are affected by the status of the UPS (Block 210).

Alternatively, determination of the affected target computers may be performed before Block 206, when the monitoring program determines whether the UPS can maintain the load. By determining the affected target computers at this earlier point, the monitoring program can calculate the load required on the UPS or determine the importance of the affected computers. Such calculations or determinations can then be used when determining whether the target computers should be shutdown in Block 208.

After determining to shutdown the affected target computers, the monitoring program then sends a shutdown instruction to the subordinate programs on the affected target computers in the network (Block 210). The monitoring program can also initiate a shutdown routine for the monitoring computer. If shutdown is not imminent for the affected target computers, the monitoring program returns to requesting status updates from the UPS (Block 200).

Referring to FIG. 2B, routines for a subordinate program on a target computer receiving a shutdown instruction from the monitoring program are illustrated. The subordinate program listens for instructions sent from the monitoring computer on the network (Block 250). Listening can be done at regular intervals or on demand. The subordinate program receives an instruction from the monitoring program (Block 252). The subordinate program listens for a specific or predetermined instruction to initiate an orderly shutdown of the computer. As a security feature, the subordinate program can be set up to receive the instruction from only a designated monitoring computer. The subordinate program can also be password protected. When the subordinate program receives instructions from the monitoring program, an optional verification routine can be performed to determine the correct receipt of the instruction using transfer protocol (Block 254).

When the instruction dictates that shutdown is imminent due to conditions of the UPS connected to the monitoring computer, for example, the subordinate program activates a local shutdown sequence (Block 256). The local shutdown sequence can involve a pre-configured delay before the subordinate program shuts down the target computer. The local shutdown sequence can also involve saving data and closing programs before shutdown. Once the requirements for the local sequence are met, the subordinate program activates a shutdown routine for the target computer (Block 258). The shutdown routine follows a pre-configured script, and shutdown then safely occurs at the target computer (Block 260).

Referring to FIG. 3, routines for monitoring a detection device using the monitoring program are illustrated. In Block 220, the detection device performs a repeating loop to detect an alarm condition, such as a fire, cooling failure, burglary, unauthorized access, or water leak, for example. If an alarm condition is detected, the detection device sends an alarm signal to the monitoring program (Block 222).

The monitoring program receives the alarm signal (Block 230). An optional verification routine can be performed to determine the correct receipt of the alarm signal using transfer protocol. The monitoring program then determines which target computers are affected by the alarm condition (Block 232). For example, a water leak may occur in a part of a building or zone of a network and may potentially compromise a number of target computers. A water detector may detect the water and send the alarm to the monitoring program. The monitoring program then determines the target computers that are dependent upon the water detector or are affected by the water leak. Once the affected target computers are determined, the monitoring program sends a shutdown signal to the subordinate programs of the affected target computers (Block 234).

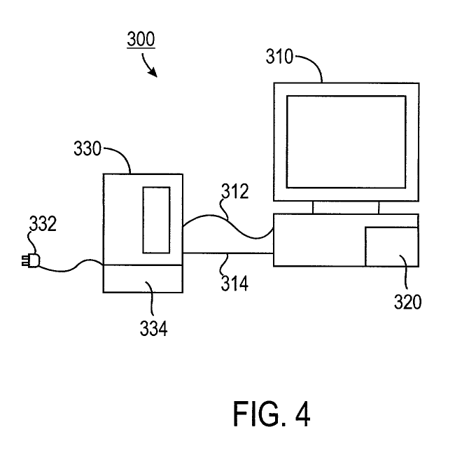

Referring to FIG. 4, another embodiment of a monitoring system 300 in accordance with the present invention is illustrated. A computer 310 is supported by an apparatus 330, which in the present embodiment is an uninterruptible power supply (UPS). UPS 330 connects to a conventional power supply 332 and provides power for computer 310 via cable 312. A connection 314 allows computer 310 to communicate with UPS 330. Connection 314 can be a cable that connects UPS 330 to a serial port on computer 310. Alternatively, connection 314 can be a network connection that connects UPS 330 to computer 310.

UPS 330 has circuitry 334, such as a network interface card and processor, that enables UPS 330 to monitor its parameters and to communicate with computer 310 via connection 314. UPS 330 monitors itself for alarm conditions and for specific operating parameters, such as on-line status, commercial power status, and battery voltage. Communication between UPS 330 and computer 310 may occur at predetermined intervals or on demand.

Commercial power may fail or be disrupted. Consequently, UPS 330 supplies power to computer 310 from a stored power supply. UPS 330 determines whether it is capable of maintaining the load. If UPS 330 determines that it is not able to handle the load, UPS 330 sends a message to a subordinate program 320 on computer 310 via cable 314. Subordinate program 320, based on the validity of the message received, performs an orderly shutdown routine of computer 310. Subordinate program 320 is pre-configured to listen for one specific message and initiate shutdown of computer 310. The transport protocol between UPS 330 and computer 310 may involve verifying receipt of the message, checking the source of the message, or decrypting the message.

Upon receiving the message, subordinate program 320 activates a local shutdown sequence for computer 310. Various routines of the shutdown sequence may warn of imminent shutdown of the UPS 330, may initiate a time delay for shutdown, or may activate scripts to save data of the computer 310. Once the shutdown sequence completes, the subordinate program 320 shuts down the computer 310.

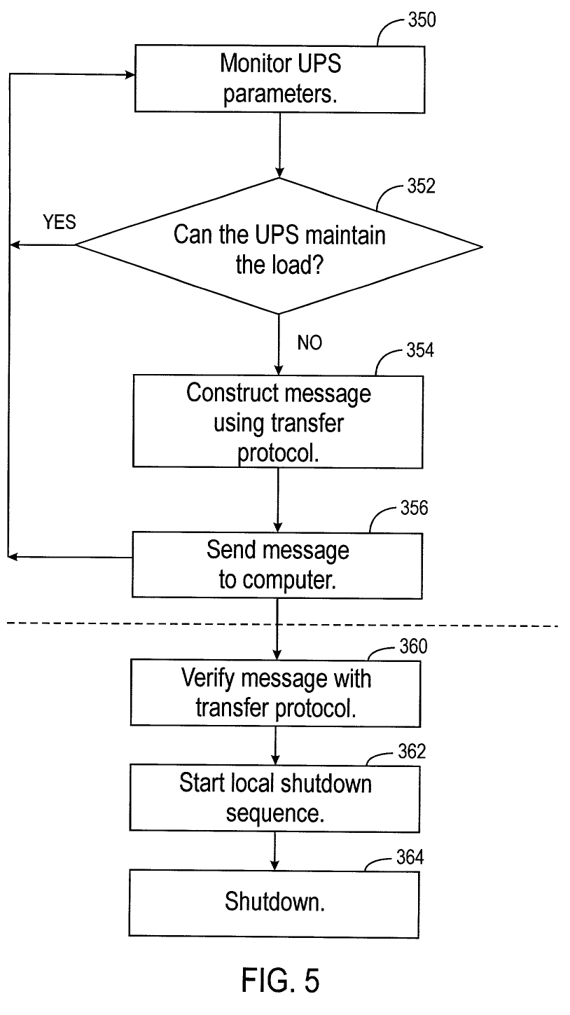

Referring to FIG. 5, routines for an uninterruptible power supply (UPS) and a subordinate program of FIG. 4 are illustrated. In the present embodiment, the UPS is equipped with a network interface card and can perform independent functions. The UPS monitors specific parameters, such as battery voltage, on-line status, or commercial power status (Block 350). The parameters are used to determine whether the UPS can maintain the load (Block 352). If the UPS can maintain the load, the UPS returns to monitoring the parameters (Block 350).

If the UPS cannot maintain the load, the UPS then constructs a message using a transfer protocol (Block 354). The UPS sends the message to the computer (Block 356). The subordinate program receives the message from the UPS and verifies the information with transfer protocol (Block 360). The subordinate program then starts local shutdown sequence (Block 362). Once the details or operations of the shutdown sequence are fulfilled, the subordinate program shuts down the computer (Block 364).

While the invention has been described with reference to the preferred embodiments, obvious modifications and alterations are possible by those skilled in the related art. Therefore, it is intended that the invention include all such modifications and alterations to the full extent that they come within the scope of the following claims or the equivalents thereof.

What is claimed is:

1. A method for monitoring an apparatus interacting with computers on a network and controlling the computers accordingly comprising:
configuring a subordinate program with a monitoring program on a monitoring computer; and
installing the configured subordinate program from the monitoring computer to a target computer.

2. The method of claim 1, further comprising receiving a message from the apparatus with the monitoring computer.

3. The method of claim 2, further comprising determining from the message if a shutdown condition exists by using the monitoring program.

4. The method of claim 3, further comprising transmitting a shutdown instruction from the monitoring program to the subordinate program if the shutdown condition exists.

5. The method of claim 4, further comprising shutting down the target computer with the subordinate program based on the received shutdown instruction.

6. The method of claim 1, wherein installing the subordinate program from the monitoring computer to the target computer comprises pushing the subordinate program to the target computer via the network.

7. The method of claim 1, wherein installing the subordinate program from the monitoring computer to the target computer comprises installing the subordinate program from a floppy diskette or other removable media.

8. The method of claim 1, wherein installing the subordinate program from the monitoring computer to the target computer comprises e-mailing the subordinate program as a file of executable code from the monitoring computer to the target computer.

9. The method of claim 1, wherein installing the subordinate program from the monitoring computer to the target computer comprises downloading the subordinate program from the monitoring computer to the target computer via the network.

10. A system for monitoring an apparatus providing support for or interacting with computers on a network, the system comprising:
a monitoring program receiving data from the apparatus and comprising:
a first routine determining an alarm condition of the apparatus from the data,
a second routine determining a target computer on the network effected by the alarm condition of the apparatus, and
a third routine sending a predetermined instruction to the affected target computer over the network; and
a subordinate program configured by the monitoring program and installed on the target computer, the subordinate program receiving the predetermined instruction and performing a shutdown routine of the affected target computer.

11. The system of claim 10, wherein the apparatus is an uninterruptible power supply.

12. The system of claim 10, wherein the apparatus is a detection device selected from the group consisting of a smoke alarm, a burglar alarm, a fire detector, a water detector, or an unauthorized access detector.

13. The system of claim 10, wherein the subordinate program is transferred from a monitoring computer having the monitoring program to the target computer via the network.

14. A system for monitoring an apparatus providing support for or interacting with computers on a network comprising:
a monitoring program performing the steps comprising:
receiving data from the apparatus,
determining an alarm condition of the apparatus,
determining a computer on the network effected by the alarm condition of the apparatus,
sending a shutdown instruction to the affected target computer; and
a subordinate program being configured by the monitoring program and installed on the target computer, the subordinate program performing the steps comprising:
receiving the shutdown instruction, and
shutting down the affected target computer.

15. The system of claim 14, wherein the subordinate program is transferred to the target computer from the monitoring program via the network.

16. The system of claim 14, wherein the apparatus is an uninterruptible power supply.

17. The system of claim 14, wherein the apparatus is a detection device selected from the group consisting of a smoke alarm, a burglar alarm, a fire detector, a water detector, or an unauthorized access detector.

18. A system for shutting down a target computer, the target computer receiving support from or interacting with an apparatus, the target computer and apparatus connected on a network, the system comprising:
a pre-configured program installed on the target computer and performing a shutdown routine of the target computer based on a predetermined instruction received from the apparatus;
a processor installed in the apparatus, the processor monitoring the apparatus for an alarm condition and creating the predetermined instruction based on the alarm condition; and
a network interface installed in the apparatus and enabling the processor to communicate the predetermined instruction to the program on the target computer via the network.

19. The system of claim 18, wherein the pre-configured program is configured by a monitoring program on a monitoring computer and is installed from the monitoring computer to the target computer via the network.

20. The system of claim 18, wherein the apparatus is a device providing an uninterruptible power supply to the target computer.
